(19) United States
(12) Patent Application Publication
(10) Pub. No.: US 2023/0213723 A1
(43) Pub. Date: Jul. 6, 2023

(54) BUNDLED DROP ASSEMBLY HAVING INCREASED STIFFNESS AND SUBUNIT LAYERS WITH UNIDIRECTIONAL WINDING

(71) Applicant: CORNING RESEARCH & DEVELOPMENT CORPORATION, Corning, NY (US)

(72) Inventor: James Arthur Register, III, Hickory, NC (US)

(21) Appl. No.: 18/119,952

(22) Filed: Mar. 10, 2023

Related U.S. Application Data
(63) Continuation of application No. PCT/US2021/048669, filed on Sep. 1, 2021.
(60) Provisional application No. 63/078,007, filed on Sep. 14, 2020.

(51) Int. Cl. G02B 6/44

(52) U.S. Cl. CPC G02B 6/449

(57) ABSTRACT

Embodiments of the disclosure relate to a bundled drop assembly. The bundled drop assembly includes a central member. The bundled drop assembly also includes an inner layer of subunits laid in a winding direction around the central member. The inner layer of subunits includes at least one subunit containing one or more optical fibers. Further, the bundled drop assembly includes at least one further layer of subunits laid around the inner layer of subunits in a same winding direction as the inner layer of subunits. The at least one further layer of subunits includes at least one subunit containing one or more optical fibers. The at least one further layer of subunits includes an outer layer of subunits that is the outermost layer of the bundled drop assembly.

### PRIORITY APPLICATION

This application is a continuation of International Application No. PCT/US2021/048669 filed Sep. 1, 2021, which claims the benefit of priority to U.S. Provisional Application Ser. No. 63/078,007 filed on Sep. 14, 2020, the content of which is relied upon and incorporated herein by reference in its entirety.

### BACKGROUND

The disclosure relates generally to bundled drop assemblies including optical fibers, and specifically to bundled drop assemblies including multiple layers of drop cables in which the layers are wound around a central strength member in the same winding direction. Optical fibers are used to transmit data optically between various points in a network. Such optical fibers may be arranged in cables originating at data hubs, and the cables may include branches that drop at various locations to deliver data to nodes in the network. A variety of cable designs exist that provide such branching within a transmission network.

### SUMMARY

According to an aspect, embodiments of the disclosure relate to a bundled drop assembly. The bundled drop assembly includes a central member. The bundled drop assembly also includes an inner layer of subunits laid in a winding direction around the central member. The inner layer of subunits includes at least one subunit containing one or more optical fibers. Further, the bundled drop assembly includes at least one further layer of subunits laid around the inner layer of subunits in a same winding direction as the inner layer of subunits. The at least one further layer of subunits includes at least one subunit containing one or more optical fibers. The at least one further layer of subunits includes an outer layer of subunits that is the outermost layer of the bundled drop assembly.

According to another aspect, embodiments of the disclosure relate to a method of preparing a bundled drop assembly. In the method, an inner layer of subunits having a plurality of optical fibers is wound around a central member in a first winding direction. Each of at least one further layer of subunits is wound around the inner layer of subunits in a second winding direction. The at least one further layer of subunits includes a plurality of optical fibers. The at least one further layer of subunits includes an outer layer of subunits that is the outermost layer of the bundled drop assembly, and the second winding direction is the same as the first winding direction.

According to a further aspect, embodiments of the disclosure relate to a bundled drop assembly. The bundled drop assembly includes a central member. Further, the bundled drop assembly includes an inner layer of subunits having a plurality of optical fibers wound around the central strength member in a first winding direction. At least one binder is wrapped around the inner layer of subunits. An outer layer of subunits having a plurality of optical fibers is wound around the binder and the inner layer of subunits in a second winding direction. The first winding direction is the same as the second winding direction, and the outer layer of subunits is the outermost layer of the bundled drop assembly.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts a cross-section of a bundled drop assembly taken inline to a longitudinal axis of the bundled drop assembly, according to an exemplary embodiment;

FIG. 2 depicts a section of the bundled drop assembly showing the winding of the first and second layer of subunits, according to another exemplary embodiment;

FIG. 3 is a graph of the excess subunit length as a function of twists for counter-helically laid subunits and for unidirectionally laid subunits, according to an exemplary embodiment;

FIG. 4 is a graph of cable length for a twist loop as a function of bend radius, according to an exemplary embodiment; and

FIG. 5 depicts a schematic representation of a processing line for applying adhesive to bond subunits to a central strength member, according to an exemplary embodiment.

### DETAILED DESCRIPTION

Referring generally to the figures, various embodiments of a bundled drop assembly having increased stiffness and layers of subunits with unidirectional winding are provided. As will be discussed more fully below, the bundled drop assembly is configured to substantially diminish or eliminate unwinding of subunits that produces undesirable bulging in the cable as a result of twisting. The bundled drop assembly includes a central member around which a first layer of subunits is wound. At least one further layer of subunits is wound around the first layer of subunits. Applicant has found that, when the first layer of subunits is wound in a different direction that a second layer of subunits, twisting can result in one layer tightening and the other layer unwinding, amplifying the effect of unwinding during twisting and producing the aforementioned bulging. According to the present disclosure, each layer of subunits is wound in the same direction so that the subunits react more uniformly during twisting. Further, Applicant has found that by increasing the stiffness of the bundled drop assembly, the effects of twisting are further reduced because the twist is spread over a longer cable length. Exemplary embodiments of the bundled drop assembly and method of manufacturing same will be described in greater detail below, and these exemplary embodiments are provided by way of illustration, and not by way of limitation.

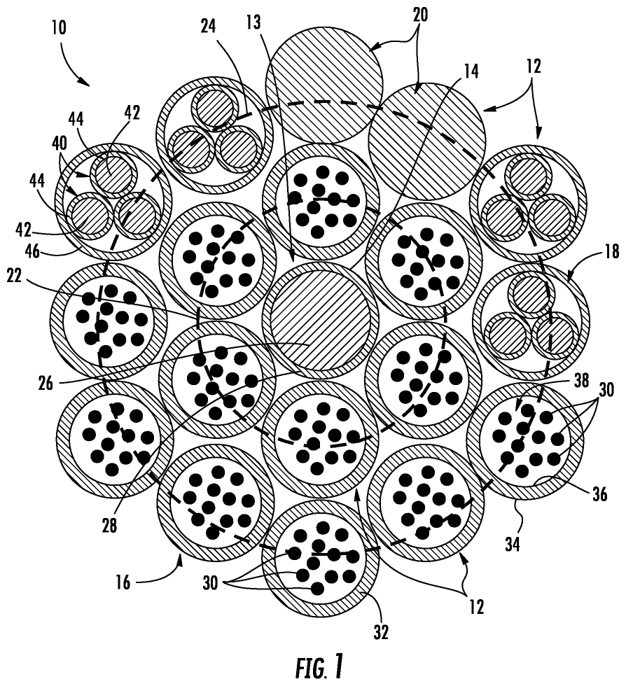

FIG. 1 depicts an exemplary embodiment of a bundled drop assembly 10. The bundled drop assembly 10 includes a plurality of subunits 12 wound around a central member 13. In the embodiment depicted, the central member 13 is a central strength member 14. However, in other embodiments, the central member 13 may be, for example, an optical fiber cable (such as a loose tube or ribbon cable) or an electrical cable (such as a power transmission cable), among other possibilities. In embodiments, the subunits 12 are at least one of an optical fiber drop cable 16, an electrical conductor cable 18, or a filler unit 20. Further, in embodiments, the subunits 12 are arranged in at least a first layer 22 and a second layer 24 around the central strength member 14. In the embodiment depicted, the first layer 22 is an inner layer, in particular the innermost layer, wrapped around the central member 13, and the second layer 24 is an outer layer, in particular the outermost layer, wrapped around the subunits 12 of the first layer 22.

In the embodiment depicted in FIG. 1, the first layer 22 includes six subunits 12. In embodiments, the first layer 22 includes from five to eighteen subunits 12. In embodiments, the number of subunits 12 in the first layer 22 depends at least in part on the diameter of the central member 13. Further, in the embodiment depicted, all of the subunits 12 of the first layer 22 are optical fiber drop cables 16; however, in other embodiments, the first layer 22 includes other subunits 12 in addition to or in place of optical fiber drop cables 16. For example, in embodiments, the first layer 22 may include any combination of optical fiber drop cables 16, electrical conductor cables 18, or filler units 20. As shown in FIG. 1, the first layer 22 of subunits 12 defines a pitch circle (dashed line), which is a circle running through the center of each of the subunits 12 in the first layer 22. As will be discussed below, the pitch circle may be used to define a laylength of the layer of subunits. Further, “laylength” as used herein refers to the linear length of the bundled drop assembly 10 over which the subunits 22 of the layer make one complete revolution around the central member 13 or other underlying layer.

In the embodiment depicted in FIG. 1, the second layer 24 includes twelve subunits 12. In embodiments, the second layer 24 includes from eleven to twenty-four subunits 12. In embodiments, each successive layer of subunits 12 includes at least six more subunits 12 than the underlying inner layer (e.g., a first layer 22 of six subunits 12, a second layer 24 of twelve subunits 12, a third layer (not shown) of eighteen subunits 12, etc.). Further, in the embodiment depicted, the subunits 12 include optical fiber drop cables 16, electrical conductor cables 18, and filler units 20. However, in other embodiments, the second layer 24 may include any combination of optical fiber drop cables 16, electrical conductor cables 18, or filler units 20. As with the first layer 22, the second layer 24 defines a pitch circle (dashed line), which may be used as a reference for laylength of the second layer 24.

As can be seen in FIG. 1, the second layer 24 of subunits 12 is the outermost layer of the bundled drop assembly 10. That is, unlike other optical fiber cables, the second layer 24 (or, more generally, the outermost layer) of subunits 12 is not surrounded by a cable jacket that encloses all of the subunits 12 of the bundled drop assembly 10 within a single structure.

In the embodiment depicted, the central member 13 in the form of a central strength member 14 includes a strength element 26 that is optionally surrounded by a jacket layer 28. In embodiments, the strength element 26 is, for example, a fiber-reinforced plastic (FRP) rod, a metal wire, or resin-impregnated yarns or strands, among others. In embodiments, the strength element 26 has a diameter of at least 3.0 mm. In further embodiments, the strength element 26 has a diameter of at least 4.0 mm. In still further embodiments, the strength element 26 has a diameter of at least 4.5 mm. In embodiments, the strength element 26 has a diameter of up to 5.0 mm. Further, in embodiments, the central strength member 14 has an outer diameter of at least 5.0 mm, and in embodiments, the central strength member 14 has an outer diameter of up to 15 mm. The jacket layer 28 is provided where the diameter of the strength element 26 is less than the desired final diameter of the central strength member 14. For example, if the desired diameter of the central strength member 14 is 5.0 mm and the strength element 26 has a diameter of 4.5 mm, then the jacket layer 28 will have a thickness of 0.25 mm. In another example, if the desired diameter of the central strength member 14 is 5.0 mm and the strength element 26 has a diameter of 5.0 mm, then the central strength member 14 may not include a jacket layer 28 at all.

In the embodiment depicted, each optical fiber drop cable 16 includes one or more optical fibers 30. The optical fibers 30 are surrounded by a cable jacket 32. The cable jacket 32 has an outer surface 34 and an inner surface 36. The inner surface 34 defines a central bore 38 in which the optical fibers 30 are disposed. In the embodiment depicted, the optical fibers 30 are arranged in a loose-tube configuration within the central bore 38. However, in other embodiments, the optical fibers 30 may be arranged in another configuration, such as in one or more ribbons, which may be in a linear, stacked, or rolled configuration. Further, each optical fiber drop cable 16 is depicted with twelve optical fibers 30, but in embodiments, each optical fiber drop cable 16 includes form one to twenty-four optical fibers 30. Additionally, in embodiments, the central bore 38 may also be filled with a variety of filling material, such as strength members (such as aramid, cotton, basalt, and/or glass yarns), water blocking gels or powders, and/or fire retardant materials, among others. The optical fiber drop cables 16 are configured to drop from the bundled drop assembly 10 at various locations along the length of the bundled drop assembly 10 so that the optical fibers 30 can deliver optical signals to installations at the drop locations. Additionally, in embodiments, the central member 13 may be an optical fiber cable substantially similar to the optical fiber drop cable 16. Further, in embodiments, the optical fiber cable central member may carry several hundred or even thousands of optical fibers (e.g., RocketRibbon™ cable, available from Corning Incorporated, Corning, N.Y.).

In the embodiment depicted, each electrical conductor cable 18 includes one or more wires 40 having a wire conductor 42 and a wire jacket 44. In embodiments, the wire conductor 42 is a stranded or solid wire. Further, in the embodiment depicted, the electrical conductor cable 18 includes three wires 40, e.g., a hot, a neutral, and a ground wire for single phase power. In embodiments, the one or more wires 40 are surrounded by a subunit jacket 46. The electrical conductor cables 18 are configured to carry electrical power, and similar to the optical fiber drop cables 16, the electrical conductor cables 18 can drop from the bundled drop assembly 10 at various locations to delivery electrical power to installations at the drop location. In embodiments, an electrical cable substantially similar to the electrical conductor cable 18 may be used as the central member 13 of the bundled drop assembly 10.

As mentioned above, the bundled drop assembly 10 may include one or more filler units 20. In embodiments, the filler units 20 may be used to provide a complete layer if optical fiber drop cables 16 or electrical conductor cables 18 are not needed for the particular installation. Additionally, in embodiments, the filler units 20 may be provided along the bundled drop assembly 10 downstream of a drop location where an optical fiber drop cable 16 or electrical conductor cable 18 drops off of the bundled drop assembly 10. In embodiments, the filler units 20 are lengths of solid polymeric material. In other embodiments, the filler units 20 include a strength yarn extending along the longitudinal axis of the filler unit 20 in which the strength yarn is surrounded by the polymeric material. Further, in embodiments, the polymeric material may be solid or foamed.

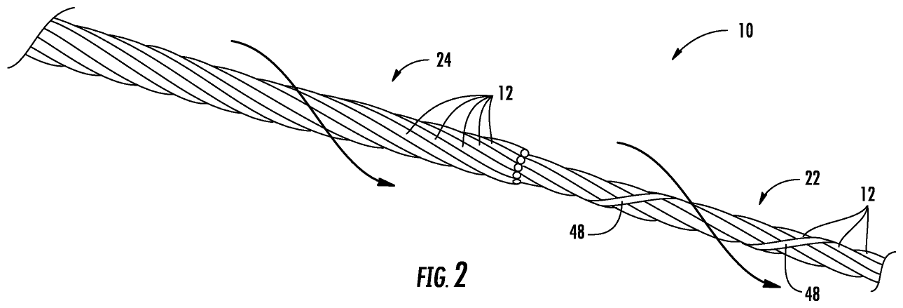

As shown in FIG. 1, the subunits 12 are laid in layers 22, 24 around the central strength member 14. FIG. 2 shows the direction of laying for the layers 22, 24. As can be seen in FIG. 2, the layers 22, 24 are unidirectionally laid. That is, the layers 22, 24 are both laid in the same direction, e.g., both layers are laid in a clockwise or counterclockwise direction. In this way, any twisting of the bundled drop assembly 10 will cause the subunits 12 of both layers 22, 24 to both tighten or loosen together. Twisting can occur when the bundled drop assemblies 10 are pulled out of a coil form a stationary location. Such pulling has a tendency to impart a 180° twist through every loop of the coil. The twist is imparted when the bundled drop assembly's stiffness overcomes the reduction in bend diameter and flips.

In certain conventional bundled drop assemblies in which the subunits of the layers were counter-helically laid, twisting of the assembly, especially at small bend radiuses where the twist is concentrated in a short liner section of the assembly, would cause the subunits of one layer to tighten and the subunits of the other layer to loosen. This can cause the layer that loosens to unbundle and bulge out from the nominal diameter of the bundled drop assembly. The bulging subunits can prevent the cable assembly from being pulled through a duct or from being overlashed in an aerial installation. Additionally, the twisting can in certain circumstances be sufficient to cause fiber or conductor failure.

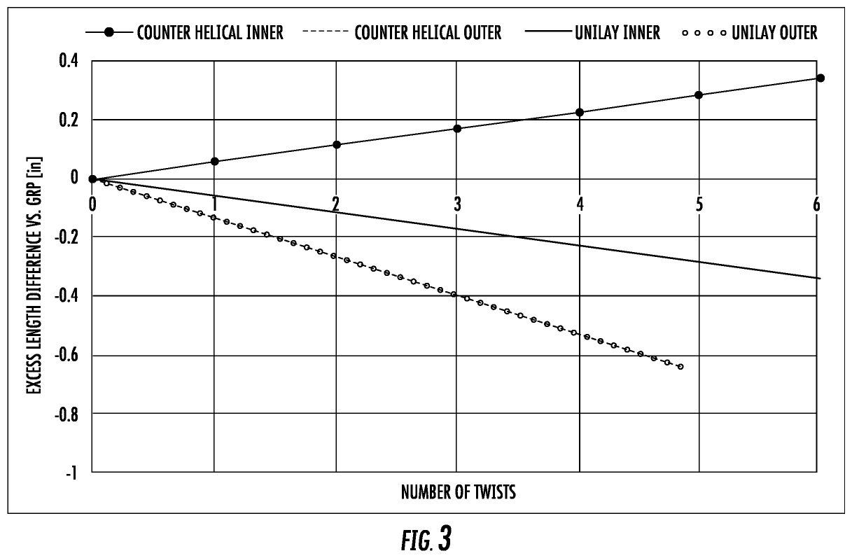

Thus, according to the present disclosure, unidirectionally laying the subunits 12 of each layer 22, 24 can prevent the combination twist tightening/loosening that can lead to bulging or cable failure. FIG. 3 is a graph illustrating the length difference that is created when the subunits of the layers are counter-helically laid as opposed to when the subunits of the layers are unidirectionally laid (referred to as “unilay” in FIG. 3). In generating the graph, the subunit layers met the design condition of laylength divided by diameter of pitch circle equal to fifteen. As can be seen in FIG. 3, the subunits of the inner layer are laid in a first direction, and the subunits of the outer layer are stranded either in the same direction as the inner layer (unilay) or in the opposite direction (counter helical). When the bundled assembly is twisted in the direction of the outer layer, the outer layer excess unit length decreases in comparison to the length of the central member. For the unidirectionally laid inner layer, the excess unit length also decreases but to a lesser extent than the outer layer. In this way, the length difference between the subunits of the inner layer and the subunits of the outer layer at three twists is about 0.23 inches. For the counter-helically laid inner layer, the direction of twisting loosens the subunits of the inner layer, thereby increasing the excess unit length. At three twists, the difference in length between the subunits of the inner layer and the subunits of the outer layer is more than doubled to 0.57 inches. In general, the unidirectional laying of the subunits of the first and second layers 22, 24 will result in about a 60% reduction in length differential as a result of twisting in comparison to counter laid subunits for the conditions tested.

In addition to the length differential between the subunits 12 of the inner and outer layers 22, 24, the bulging of the subunits 12 is also influenced by the cable length over which the twisting is spread. In particular, spreading the twisting over a larger cable length will reduce the bulging of the subunits 12 from the bundled drop assembly 10. Increasing the stiffness of the bundled drop assembly 10 is one way to increase the cable length over which the twist is introduced into the bundled drop assembly 10 because a stiffer bundled drop assembly 10 will have a larger bend diameter than a less stiff bundled drop assembly, leading to larger twist loops into which the cable length is formed.

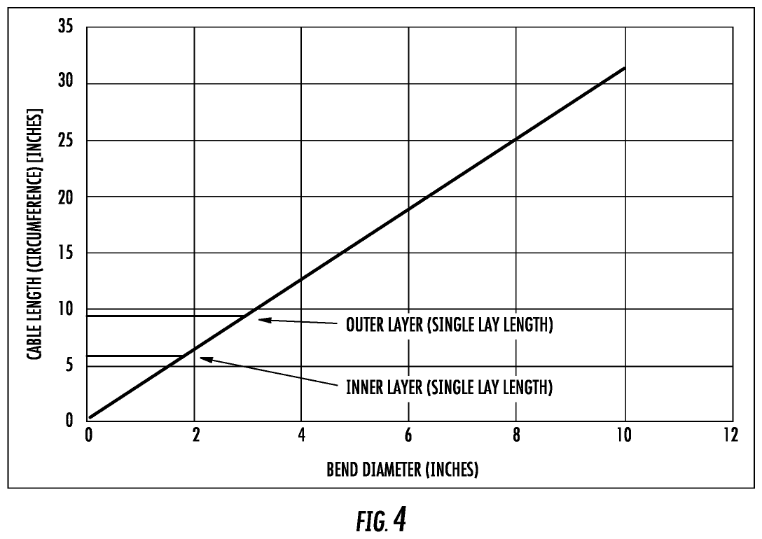

FIG. 4 depicts a chart showing cable length (i.e., circumference of twist loop) as a function of bend diameter. On the chart, the cable length corresponding to a single lay length of the inner layer 22 of subunits 12 and to a single lay length of the outer layer 24 of subunits 12 according to an exemplary embodiment are shown. To distribute the twist over a greater cable length, the stiffness of the bundled drop assembly 10, in embodiments, is increased so that the bend diameter from twisting is increased. Thus, for an inner layer 22 having a laylength of 150 mm, the bundled drop assembly 10, in embodiments, is made stiff enough that the bend diameter is at least about 1.9 inches, which corresponds to a cable length of about 5.9 inches. Accordingly, a twist loop induced in the bundled drop assembly 10 having a sufficient stiffness such that the bend diameter is greater than 1.9 inches will distribute the twist over a cable length that is greater than the laylength of the subunits 12 of the inner layer 22. Further, in an embodiment, the outer layer 24 has a laylength of 240 mm, and thus, in embodiments, the bundled drop assembly 10 is made stiff enough that the bend diameter is at least about 3.0 inches, which corresponds to a cable length of about 9.4 inches. Accordingly, a twist loop induced in the bundled drop assembly 10 having a sufficient stiffness such that the bend diameter is greater than 3.0 inches will distribute the twist over a cable length that is greater than the laylength of the subunits 12 of the outer layer 24.

In the following discussion, several methods of increasing the stiffness of the bundled drop assembly 10 are discussed. Each of these methods may be used alone or in combination with one of the other disclosed methods in order to provide the desired stiffness of the bundled drop assembly 10.

With reference to FIG. 1, a first method of increasing the stiffness of the bundled drop assembly 10 is to increase the stiffness of the central member 13. With respect to the embodiment depicted in FIG. 1, the central member 13 is a central strength member 14, and the stiffness can be increased by increasing the diameter of the strength element 26. As shown in FIG. 1, the central strength member 14 includes the strength element 26 and an optional jacket layer 28. For a central strength member 14 of a given diameter, a higher ratio of strength element 26 diameter to central strength member 14 diameter will lead to a stiffer central strength member. As discussed above, for a central strength member 14 have a diameter of 5.0 mm, the diameter of the strength element 26 is, in embodiments, greater than 3.0 mm. In such embodiments, the diameter of the strength element 26 is up to 5.0 mm. The thickness of the jacket layer 28 is adjusted accordingly, including the situation where no jacket layer 28 is provided at all.

Further, in embodiments in which the bundled drop assembly 10 includes electrical conductor cables 18, the stiffness of the bundled drop assembly 10 can be increased by increasing the gauge of the wire conductor 42 or by reducing the number of strands in the wire conductor 42. For example, for a single wire conductor 42, the gauge can be 16 AWG or larger (by “larger,” it is meant that the diameter of the wire conductor is larger, which is a lower AWG number). Further, for a stranded wire conductor 42 of a certain gauge, the number of strands in the wire conductor 42 can be decreased or the stranded wired conductor 42 can be replaced with a single wire conductor 42. In embodiments, the gauge of the stranded wire conductor 42 is at least 12 AWG or larger (by “larger,” it is meant that the diameter of the stranded wire conductor is larger, which is a lower AWG number).

With reference to FIG. 2, another method of increasing the stiffness of the bundled drop assembly 10 is to wrap the first layer 22 with one or more binders 48. In embodiments, the binder 48 is a yarn or ribbon wrapped around the subunits 12 of the first layer 22. The binder 48 helps to prevent the subunits 12 of the first layer 22 from unwinding during twisting, and the binder 48 prevents subunits 12 of the second layer 24 from digging in between the subunits 12 of the first layer 22 when tightened during twisting. In embodiments, a binder 48 is used around each layer of subunits 12 inside of the outermost layer of subunits 12. In embodiments, the binder 48 is a polyester ribbon having a width or diameter of about 2 mm or less, in particular about 1 mm. For a single yarn or ribbon, the binder 48 is wrapped around the first layer 22 counter-helically to the direction of winding of the subunits 12 of the first layer 22. If more than one yarn or ribbon is used, then one binder 48 may be wrapped unidirectionally with the winding of the subunits 12, and another binder 48 may be wrapped counter-helically with the winding of the subunits 12. In embodiments, each binder 48 has a laylength that is equal to or less than the laylength of the subunits 12 of the first layer 22.

In embodiments in which at least one binder 48 is used, the stiffness of the bundled drop assembly 10 can be further increased by increasing the laylength of the subunits 12 of the first layer 22. Conventionally, the laylength of the subunits 12 was configured to be no more than fifteen times the diameter of the pitch circle running through the first layer 22 of subunits 12 (dashed line shown in FIG. 1). However, where at least one binder 48 is used, the laylength can be increased to more than fifteen times the diameter of the pitch circle of the first layer 22. In embodiments, the laylength may be up to thirty times the diameter of the pitch circle of the first layer 22.

Table 1, below, provides example laylengths for bundled drop assemblies 10 based on the diameter of the central member 13, number of subunits 12, and layer 22, 24. The laylengths provided in Table 1 can be considered minimum laylengths if the layer is surrounded by a binder 48.

TABLE 1
Laylength of Subunits per Layer

| Number of | Central Member | Layer 1 | Layer 2 | Layer 3 |
|---|---|---|---|---|
| Subunits in | Diameter | laylength | laylength | laylength |
| first layer | (mm) | (mm) | (mm) | (mm) |
| 5 | 3.50 | 118.5 | 233.8 | 331.5 |
| 6 | 5.00 | 141 | 254.8 | 351 |
| 7 | 6.40 | 162 | 274.4 | 369.2 |
| 8 | 7.90 | 184.5 | 295.4 | 388.7 |
| 9 | 9.40 | 207 | 316.4 | 408.2 |
| 10 | 10.90 | 229.5 | 337.4 | 427.7 |
| 12 | 14.20 | 279 | 383.6 | 470.6 |

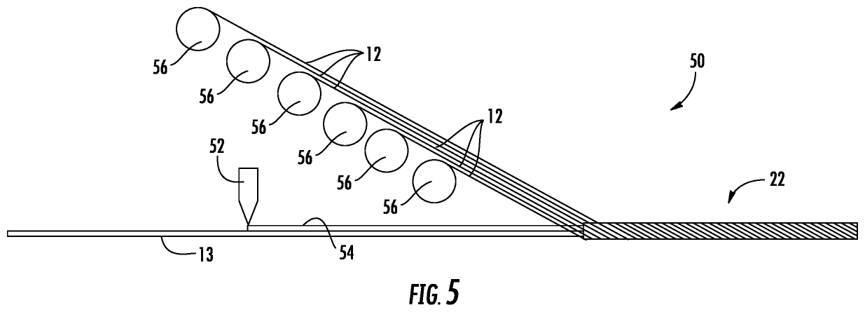

Referring now to FIG. 5, another method of increasing the stiffness of the bundled drop assembly 10 is depicted. In particular, FIG. 5 depicts a schematic representation of a processing line 50 in which an applicator 52 applies adhesive 54 to the central member 13 prior to winding of the subunits 12 of the first layer 22 around the central member 13. In the embodiment shown in FIG. 5, the applicator 52 applies a bead of adhesive 54 along the length of the central member 13. The subunits 12 are unspooled from payoff reels 56, which may be held by a planetary stranding machine (not shown), and wound around the central strength member 14 at the desired laylength. Because of the adhesive 54 applied to the central member 13, the subunits 12 are joined to the central member 13 at at least one location per laylength, effectively spot bonding the subunits 12 to the central member 13. In embodiments, the adhesive 54 is an epoxy hot melt, such as BAMFutura 55 (available from BeardowAdams, Inc., Charlotte, N.C.). The adhesive 54 bonds the subunits 12 to the central member 13, which increases the stiffness of the bundled drop assembly 10 and prevents the subunits 12 from unwinding from the central member 13 during twisting.

As mentioned above, any one of these methods may be used alone or in combination with any one of the other methods to increase the stiffness of the bundled drop assembly 10. However, in embodiments, any or all of the methods of increasing the stiffness are used in combination with the unidirectional laying of the subunits 12 of the layers 22, 24. The combination of unidirectional laying of the subunits 12 of each layer 22, 24 and increasing the stiffness of the bundled drop assembly 10 substantially diminishes or eliminates the effects of unwinding and consequent bulging of subunits 12 that would otherwise result during twisting of the bundled drop assembly 10.

Furthermore, the construction of the bundled drop assembly 10 according to the present disclosure has other incidental advantages. For example, because the subunits 12 of each layer 22, 24 are wound in the same direction, they can also be unwound in the same direction, thereby providing easier mid-span access to the first layer 22 of subunits 12. Additionally, the longer laylengths of the subunits 12 of the first layer 22 allow for increased linespeed as the longer laylengths take less time to wind. Further, the multilayer 22, 24 processing can be done in a single pass where the payoff and take-up reels of the central member 13 are twisted to provide unidirectional laying of each layer 22, 24 of subunits 12 around the central member 13 (instead of spinning the subunits around the central member, which would require multiple passes if the layers counter-helically laid).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A bundled drop assembly, comprising:
a central member;
an inner layer of subunits laid in a winding direction around the central member, the inner layer of subunits comprising at least one subunit containing at least one first optical fiber; and
at least one further layer of subunits laid around the inner layer of subunits in a same winding direction as the inner layer of subunits, the at least one further layer of subunits comprising at least one subunit containing at least one second optical fiber;
wherein the at least one further layer of subunits comprises an outer layer of subunits that is an outermost layer of the bundled drop assembly.

2. The bundled drop assembly of claim 1, wherein the central member comprises a central strength member, an optical fiber cable, or an electrical cable.

3. The bundled drop assembly of claim 1, further comprising at least one binder wrapped wound around the inner layer of subunits.

4. The bundled drop assembly of claim 3, wherein the inner layer of subunits define a pitch circle having a diameter and wherein a laylength of the inner layer of subunits is more than fifteen times the diameter of the pitch circle.

5. The bundled drop assembly of claim 3, wherein the at least one binder has a laylength equal to or less than a laylength of the inner layer of subunits.

6. The bundled drop assembly of claim 1, further comprising an adhesive between the central member and the inner layer of subunits.

7. The bundled drop assembly of claim 6, wherein the adhesive bonds each subunit of the inner layer of subunits to the central member at at least one location per laylength of the subunit.

8. The bundled drop assembly of claim 1, wherein one or both of the inner layer of subunits or the at least one further layer of subunits comprises at least one electrical conductor cable, wherein the at least one electrical conductor cable comprises at least one wire having a gauge of 16 AWG or larger for solid wire or a gauge of 12 AWG or larger for stranded wire.

9. A method of preparing a bundled drop assembly, comprising:
winding an inner layer of subunits comprising a plurality of optical fibers around a central member in a first winding direction;
winding each of at least one further layer of subunits around the inner layer of subunits in a second winding direction;
wherein the at least one further layer of subunits comprises a plurality of optical fibers, wherein the at least one further layer of subunits comprises an outer layer of subunits that is an outermost layer of the bundled drop assembly, and wherein the second winding direction is the same as the first winding direction.

10. The method of claim 9, further comprising wrapping at least one binder around the inner layer of subunits and each of the at least one further layer of subunits except for the outer layer of subunits.

11. The method of claim 10, wherein each layer of subunits defines a pitch circle having a diameter and wherein each layer of subunits around which the at least one binder is wrapped has a laylength that is more than fifteen times the diameter of the pitch circle.

12. The method of claim 10, wherein each of the at least one binder has a width of 2 mm or less.

13. The method of claim 9, further comprising applying an adhesive bead along a length of the central member prior to winding the inner layer of subunits.

14. The method of claim 9, wherein the central member comprises at least one of a central strength member, an electrical cable, or an optical fiber cable.

15. The method of claim 9, wherein at least one of the inner layer of subunits or the at least one further layer of subunits comprises at least one electrical conductor cable, wherein the at least one electrical conductor cable comprises at least one wire having a gauge of 16 AWG or larger for solid wire or a gauge of 12 AWG or larger for stranded wire.

16. A bundled drop assembly, comprising:
a central member;
an inner layer of subunits comprising a first plurality of optical fibers wound around the central member in a first winding direction;
at least one binder wrapped around the inner layer of subunits;
an outer layer of subunits comprising a second plurality of optical fibers wound around the at least one binder and the inner layer of subunits in a second winding direction;
wherein the first winding direction is the same as the second winding direction; and
wherein the outer layer of subunits is an outermost layer of the bundled drop assembly.

17. The bundled drop assembly of claim 16, wherein the central member comprises a central strength member, an optical fiber cable, or an electrical cable.

18. The bundled drop assembly of claim 16, wherein the inner layer of subunits defines a pitch circle having a diameter and wherein the a laylength of the inner layer of subunits is more than fifteen times the diameter of the pitch circle.

19. The bundled drop assembly of claim 16, further comprising an adhesive between the central member and the inner layer of subunits.

20. The bundled drop assembly of claim 16, wherein the bundled drop assembly does not comprise a jacket around the outer layer of subunits.
